(19) United States
(12) Patent Application Publication
(10) Pub. No.: US 2016/0106063 A1
(43) Pub. Date: Apr. 21, 2016

(54) Pet bowl liner

(71) Applicant: Salpi Keshishian, Reseda, CA (US)

(72) Inventor: Salpi Keshishian, Reseda, CA (US)

(21) Appl. No.: 14/887,056

(22) Filed: Oct. 19, 2015

Related U.S. Application Data
(60) Provisional application No. 62/065,763, filed on Oct. 20, 2014.

(51) Int. Cl. A01K 5/01

(52) U.S. Cl. CPC A01K 5/0121; A01K 5/0128

(57) ABSTRACT

A disposable pet bowl liner provides an elastic or adhesive edge such that it may be secured to the rim of the bowl. The liner is waterproof, is provided in several sizes and shapes corresponding to all commercially manufactured pet bowls, and is contoured to closely fit the interior surface of the bowl. When the liner becomes soiled, it is removed and discarded.

### CROSS-REFERENCE TO RELATED APPLICATIONS

This Application claims the benefit of U.S. Provisional Application No. 62/934,906, filed Oct. 03, 2014, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM

### LISTING COMPACT DISK APPENDIX

Not Applicable

### BACKGROUND OF THE INVENTION

The invention relates generally to pet care equipment and supplies, and in particular to a disposable pet bowl liner. People love their pets, but with today's fast-paced lifestyles, the amount of time that needs to be invested in properly caring for a pet may seem excessive. Washing the pet's food and water bowls is one of many tasks which are time consuming, particularly for bowls which are not dishwasher safe and must be washed by hand. The accumulation of dirt, grime, and partially masticated pet food can be a health risk to both animals and humans. Pets deserve proper care, and therefore any device which would save time during the course of performing these tasks would be well received. A disposable pet bowl liner, which may be easily removed and discarded when it becomes soiled, would satisfy this demand.

### SUMMARY OF THE INVENTION

Accordingly, the invention is directed to a disposable pet bowl liner. The liner provides an elastic or adhesive edge such that it may be secured to the rim of the bowl. The liner is waterproof, is provided in several sizes and shapes corresponding to all commercially manufactured pet bowls, and is contoured to closely fit the interior surface of the bowl. When the liner becomes soiled, it is removed and discarded.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serves to explain the principles of the invention.

FIG. 1 is a side perspective view of the first exemplary embodiment installed on a pet bowl, displaying the liner 10, the edge 11, the band 12, and the bowl 13.

FIG. 2 is a side perspective transparency view of the first exemplary embodiment, displaying the liner 10, the edge 11, and the band 12.

FIG. 3 is a top perspective transparency view of the first exemplary embodiment, displaying the liner 10, the edge 11, and the band 12.

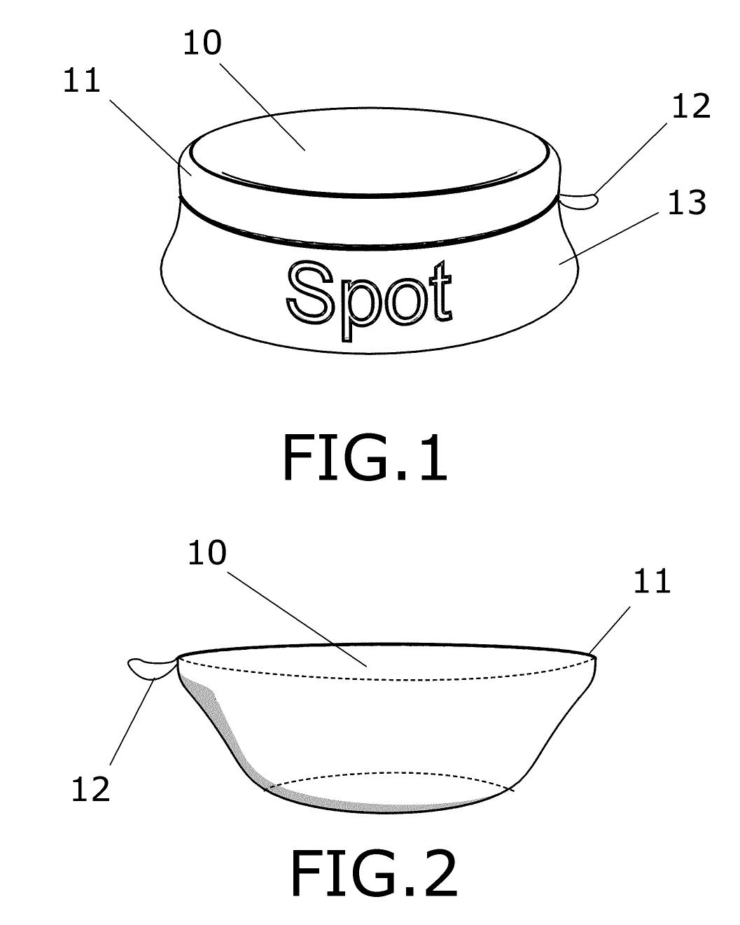

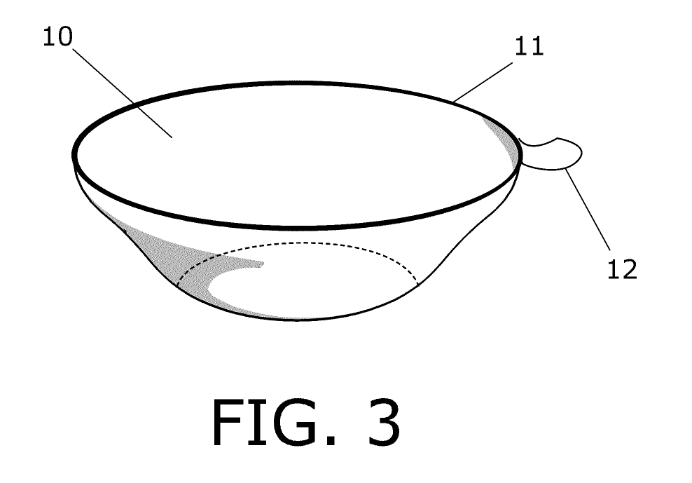

### DETAILED DESCRIPTION OF THE INVENTION

Referring now to the invention in more detail, the invention is directed to disposable pet bowl liner 10.

The first exemplary embodiment is comprised of a disposable pet bowl liner 10 which provides an elastic band 12 within its edge 11, such that it may be used as a drawstring to secure the edge 11 to the rim of the bowl 13. An alternate embodiment, wherein the band 12 is not provided and the edge 11 provides a mild adhesive, is contemplated. The liner 10 is waterproof, is provided in several sizes and shapes corresponding to all commercially manufactured pet bowls 13, and is contoured to closely fit the interior surface of the bowl 13.

To use the first exemplary embodiment, the user places the liner 10 in the bowl 13 and gently tugs on the band 12. This tightens the edge 11 of the liner 10 around the rim of the bowl 13, securing it in place by friction and flexibility. The user may then fill the liner 10 with pet food or water as desired. When the liner 10 becomes soiled, it is removed and discarded.

The liner 10 is preferably manufactured from a flexible, disposable material, such as plastic. The band 12 is preferably manufactured from a flexible, disposable material with an elastic quality, such as rubber. Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1) A pet bowl liner, comprising:
(a) a bowl liner having an edge;
(b) said bowl liner further comprising a means of securing said bowl liner to a bowl around the edge of said bowl liner;
(c) said bowl liner being waterproof;
(d) said bowl liner being sized to conform and fit within said bowl; and
(e) said bowl liner being contoured to closely fit the interior surface of said bowl.

2) The pet bowl liner of claim 1, wherein said means of securing said bowl liner to a bowl is an elastic band running around the edge of said bowl liner.

3) The pet bowl liner of claim 2, wherein said elastic band further comprises a drawstring to tighten said edge of said bowl liner around said bowl.

4) The pet bowl liner of claim 1, wherein said means of securing said bowl liner to a bowl is a mild adhesive applied around the edge of said bowl liner.

5) A pet bowl liner and method of use, wherein said pet bowl liner comprising:
(a) a bowl liner having an edge;
(b) said bowl liner further comprising a means of securing said bowl liner to a bowl, having a rim, around the edge of said bowl liner;
(c) said bowl liner being waterproof;
(d) said bowl liner being sized to conform and fit within said bowl;
(e) said bowl liner being contoured to closely fit the interior surface of said bowl;
and a method comprising:
(f) a user placing said bowl liner within said bowl;
(g) said user securing said bowl liner to said bowl using said means of securing said bowl liner;
(h) said user filling said bowl liner with food or water; and
(i) said user removing said bowl liner from said bowl when said bowl liner becomes soiled.

6) The pet bowl liner and method of use of claim 5, wherein said means of securing said bowl liner is an elastic band around the edge of said bowl liner; when said user secures said bowl liner to said bowl, said user stretches said elastic band over the rim of said bowl.

7) The pet bowl liner and method of use of claim 6, wherein said elastic band further comprises a drawstring; after said user stretches said elastic band over the rim of said bowl, said user pulls on said drawstring to tighten the edge of said bowl liner around the rim of said bowl.

8) The pet bowl liner and method of use of claim 5, wherein said means of securing said bowl liner is a mild adhesive applied around the edge of said bowl liner; when said user secures said bowl liner to said bowl, said user pulls the edge of said bowl liner over the rim of said bowl; said user applies light pressure to said mild adhesive until said bowl liner is secured to said bowl.
